(19) United States
(12) Patent Application Publication
(10) Pub. No.: US 2025/0388253 A1
(43) Pub. Date: Dec. 25, 2025

(54) ELECTRIC WHEELBARROWS

(71) Applicant: KO2 Industries LLC, St. Louis, MO (US)

(72) Inventor: Brian Cedric Koscielski, St. Louis, MO (US)

(21) Appl. No.: 19/244,179

(22) Filed: Jun. 20, 2025

Related U.S. Application Data
(60) Provisional application No. 63/662,520, filed on Jun. 21, 2024.
(60) Provisional application No. 63/663,529, filed on Jun. 24, 2024.

(51) Int. Cl. B62B 5/00; B62B 1/16

(52) U.S. Cl. CPC B62B 5/0043; B62B 1/16; B62B 5/0053

(57) ABSTRACT

Disclosed are exemplary embodiments of electric wheelbarrows. In exemplary embodiments, the electric wheelbarrow's first and second wheels are rotatably coupled to respective first and second end portions of a fixed, static, or non-rotating axle. First and second electric brushless geared hub motors are respectively coupled to the first and second wheels. The first and second electric brushless geared hub motors are configured to be operable for rotating/driving the respective first and second wheels, respectively, when electrical power is supplied to the first and second electric brushless geared hub motors.

### CROSS-REFERENCE TO RELATED APPLICATIONS

This application claims the benefit of and priority to U.S. Provisional Patent Application No. 63/662,520 filed Jun. 21, 2024 and U.S. Provisional Patent Application No. 63/663,529 filed Jun. 24, 2024. The entire disclosures of these provisional patent applications are incorporated herein by reference.

### FIELD

The present disclosure relates to electric wheelbarrows.

### BACKGROUND

This section provides background information related to the present disclosure which is not necessarily prior art.

Conventionally, wheelbarrows are two-wheeled or single-wheeled hand-propelled vehicles designed for carrying and transporting loads. A wheelbarrow typically consists of a shallow or deep container (often made of metal or plastic) supported by a frame with one or two wheels at the front and one or two handles at the rear for pushing and maneuvering the wheelbarrow. Wheelbarrows are commonly used for carrying loads such as soil, gravel, or other materials in gardening, construction, and agriculture. Wheelbarrows come in various sizes and configurations depending on their intended use, amount of material to be transported, and terrain on which the wheelbarrow will be used on.

### DRAWINGS

The drawings described herein are for illustrative purposes only of selected embodiments and not all possible implementations and are not intended to limit the scope of the present disclosure.

FIG. 1 shows an electric wheelbarrow according to an exemplary embodiment of the present disclosure.

FIGS. 2 and 3 show the electric wheelbarrow shown in FIG. 1 after being unloaded.

FIGS. 4 and 5 shows a bottom portion of the electric wheelbarrow shown in FIGS. 1, 2, and 3 including the electric wheelbarrow's first and second wheels, fixed non-rotating axle including opposite first and second end portions to which the first and second wheels are rotatably coupled, and first and second electric brushless geared hub motors coupled with the respective first and second wheels. The first and second electric brushless geared hub motors are configured to be operable for distributing electrical power to and/or between the first and second wheels for rotating/driving the first and second wheels, respectively.

FIG. 6 shows a closeup of one of the wheels and geared brushless hub of the electric wheelbarrow shown in FIGS. 4 and 5.

FIG. 7 shows the control box and variable speed control (e.g., thumb-actuated throttle/accelerator lever, etc.) of the electric wheelbarrow shown in FIGS. 1 and 2.

FIG. 8 shows a close up of the controls of the electric wheelbarrow's control box shown in FIG. 7 for controlling the electrically-powered operation of the electric wheelbarrow.

FIGS. 9 and 10 show the interior of the control box shown in FIG. 7 including the electrical power source, controller, and terminal block of the electric wheelbarrow according to an exemplary embodiment.

FIGS. 11 and 12 respectively show the electric wheelbarrow shown in FIGS. 1 and 2 while being used to haul 500 pounds of material up a 25 degree slope and over two-inch by four-inch (2×4) pieces of lumber laying on the ground according to an exemplary embodiment of the present disclosure.

FIG. 13 includes specifications for an electric wheelbarrow according to an exemplary embodiment of the present disclosure. As shown in FIG. 13, the electric wheelbarrow may be configured to include a 16 inch brushless geared hub motor (tires 4to 8), a hall sensor (5 hall wires), pneumatic inner and outer tires, and an 8 inch motor wheel size (rim). FIG. 13 also includes line graphs of power input (Pin) in watts (W), voltage source (U) in volts (V), electric current (I) in amps (A), power output (Pout) in watts (W), rotational speed (N) in revolutions per minute (RPM), and efficiency percentage (%) versus torque (T) in Newton-meters (N·m).

FIGS. 14 through 20 shows an electric wheelbarrow according to another exemplary embodiment of the present disclosure. In this exemplary embodiment, the electric wheelbarrow shown in FIGS. 14 through 20 is electrically the same or essentially identical as the wheelbarrow shown in FIGS. 1 through 12. But the electric wheelbarrow shown in FIGS. 14 through 20 has been modified or reconfigured to mechanically adjust (e.g., improve upon, etc.) the fixed, static, or non-rotating axle (FIGS. 16, 18, and 20) and to modify or reduce the size of the control box (FIGS. 15 and 19).

### DETAILED DESCRIPTION

Example embodiments will now be described more fully with reference to the accompanying drawings.

Disclosed are exemplary embodiments of electric wheelbarrows. In exemplary embodiments, the electric wheelbarrow's first and second wheels are rotatably coupled to respective first and second end portions of a fixed, static, or non-rotating axle. First and second electric brushless geared hub motors are respectively coupled to the first and second wheels. The first and second electric brushless geared hub motors are configured to be operable for rotating/driving the respective first and second wheels, respectively, when electrical power is supplied to the first and second electric brushless geared hub motors.

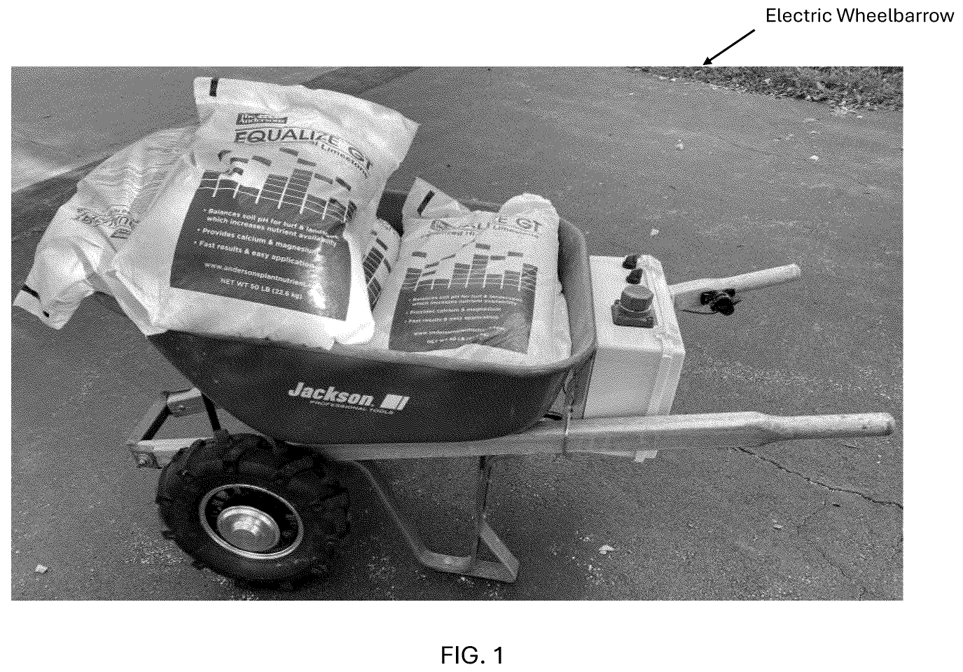

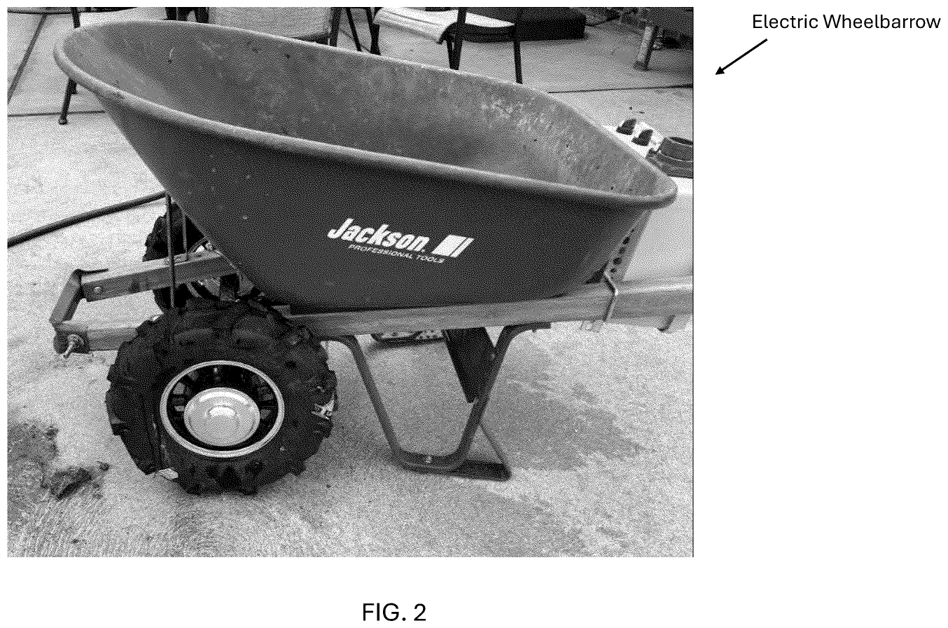

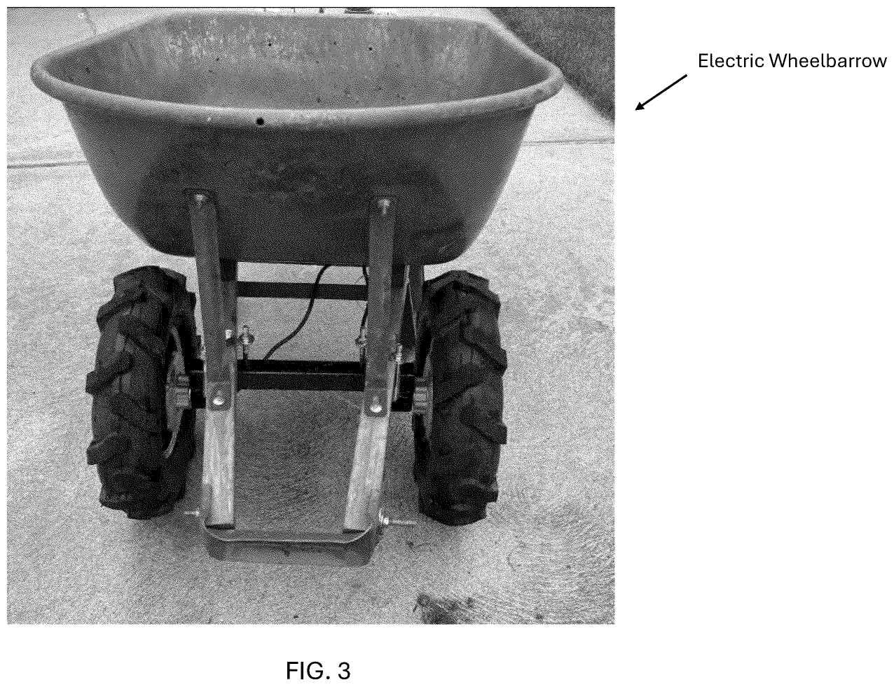

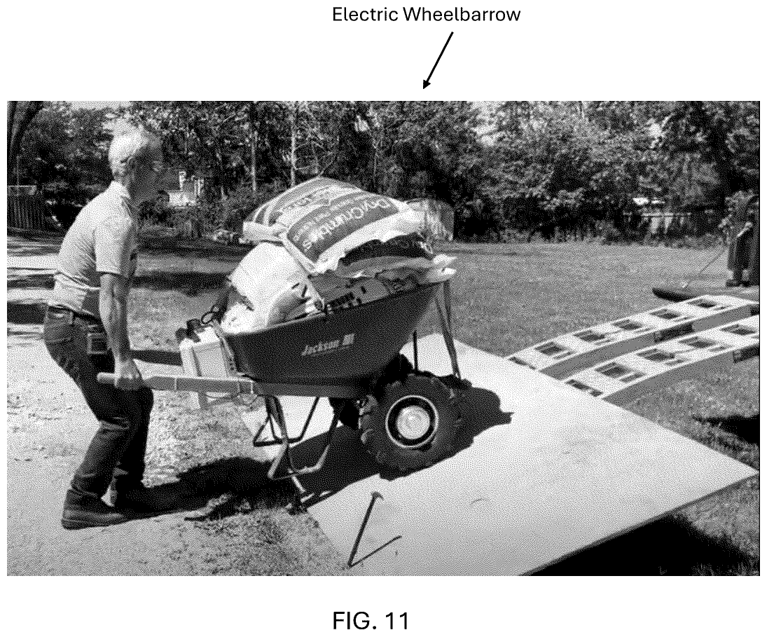

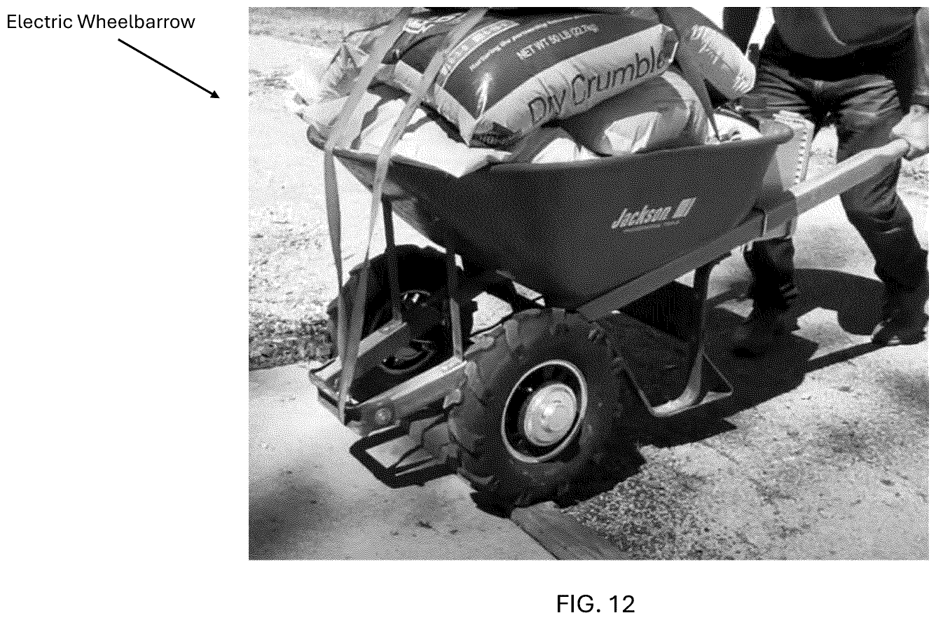

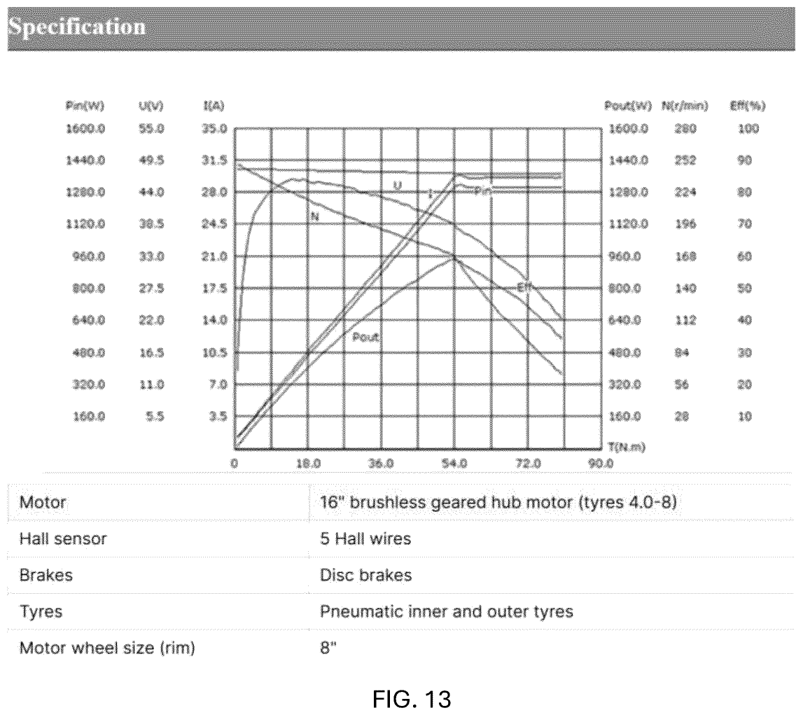

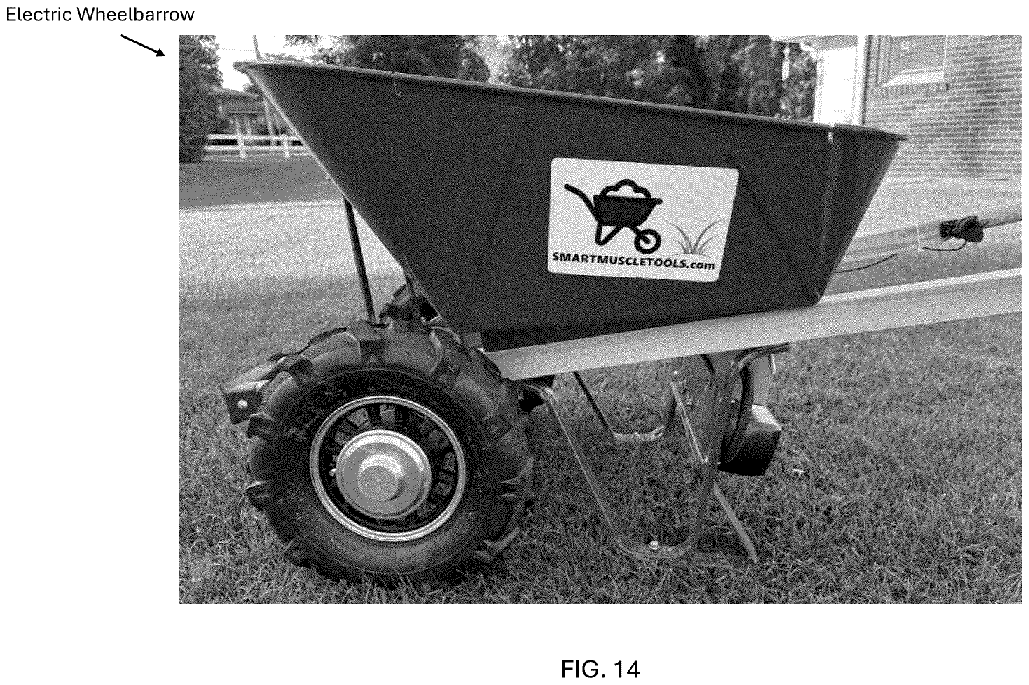

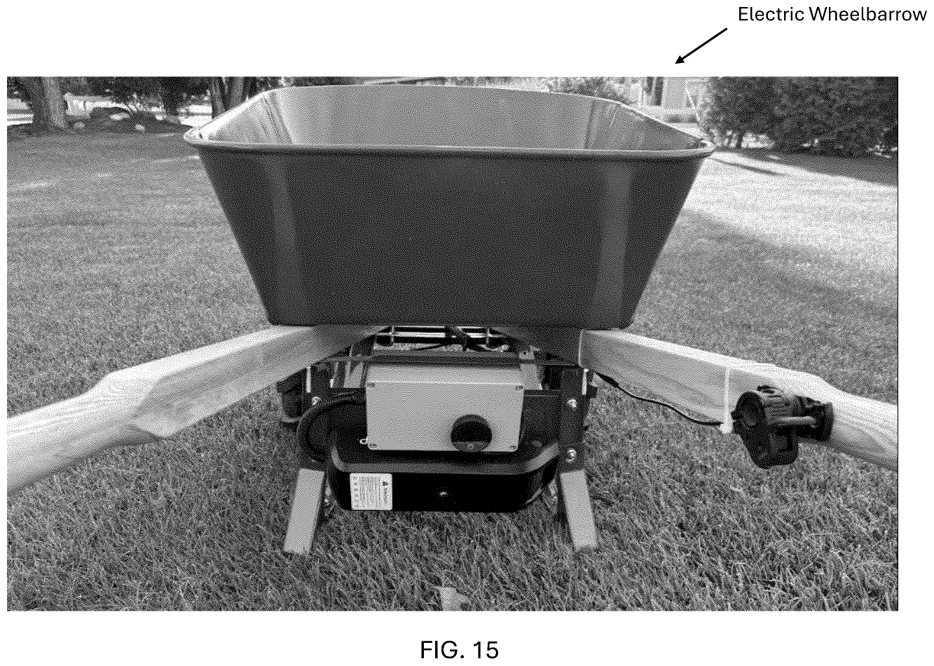

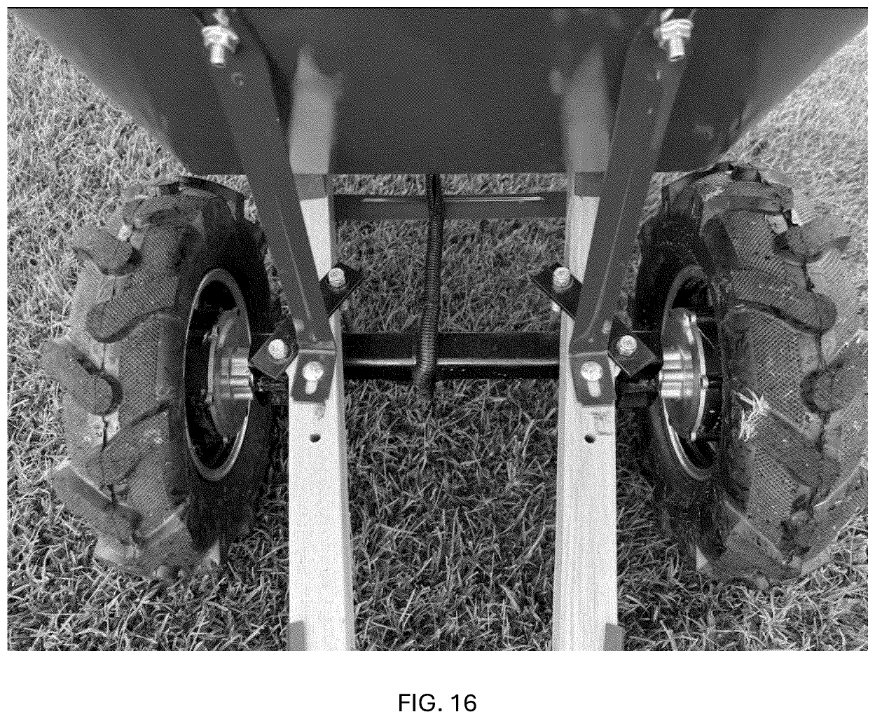

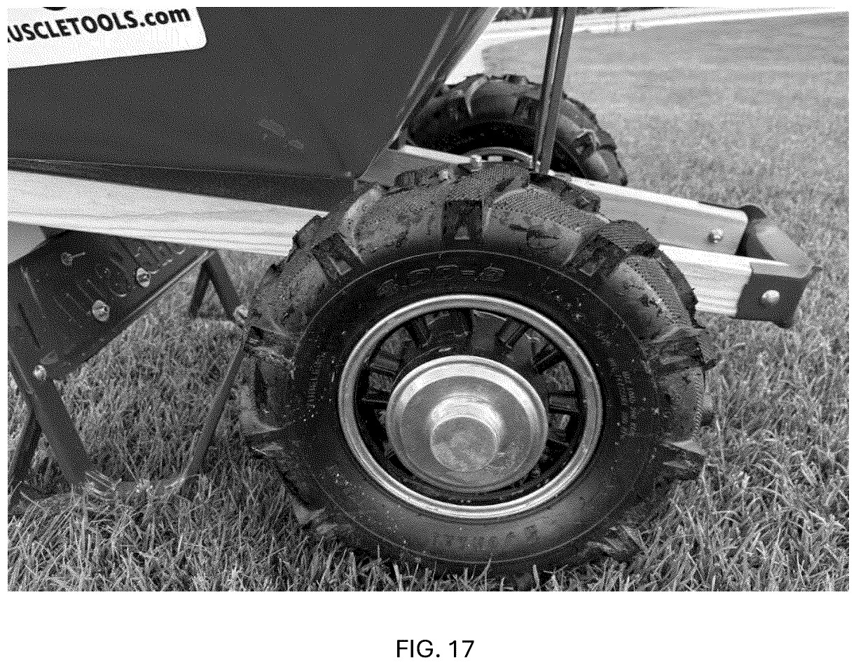

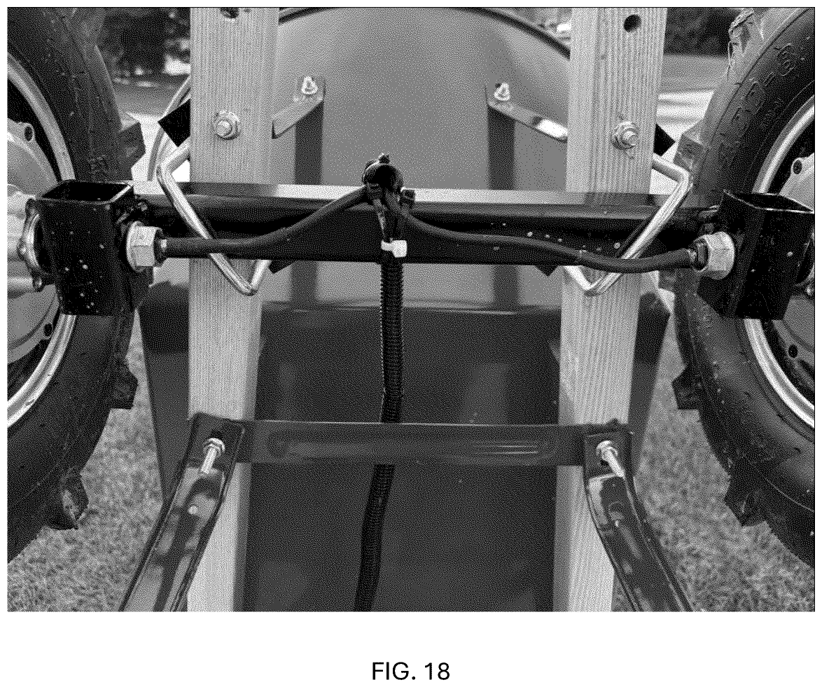

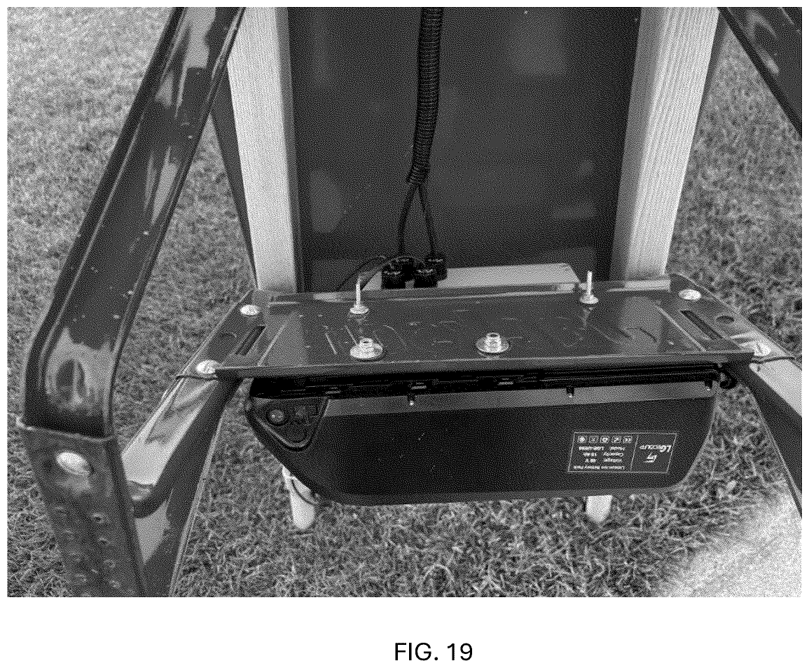

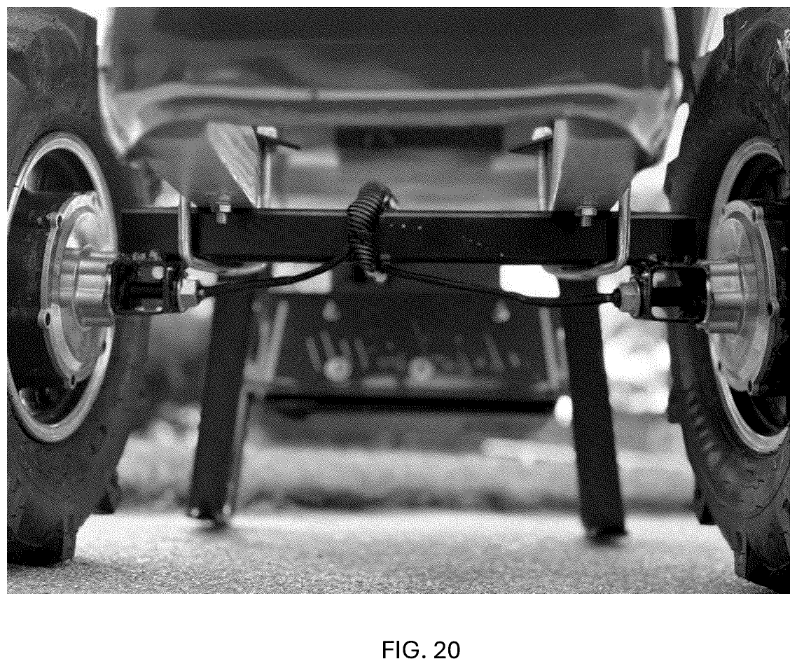

With reference to the figures, FIG. 1 shows an electric wheelbarrow according to an exemplary embodiment of the present disclosure. For purpose of example only, the electric wheelbarrow is shown with a 350 pound load comprising seven 50-pound bags of limestone. FIGS. 2 and 3 show the electric wheelbarrow shown in FIG. 1 after being unloaded. Also for purposes of example only, FIG. 11 shows the electric wheelbarrow while being used to haul 500 pounds of material up a 25 degree slope. And FIG. 12 shows the electric wheelbarrow while being used to haul 500 pounds of material over two-inch by four-inch (2×4) pieces of lumber laying on the ground. Also, the electric wheelbarrow may also have the capability to haul 1000 pounds of material into and out of a ditch even though the 1000 pound load, which 1000 pound load may exceed a maximum hauling load weight capacity of the wheelbarrow's container.

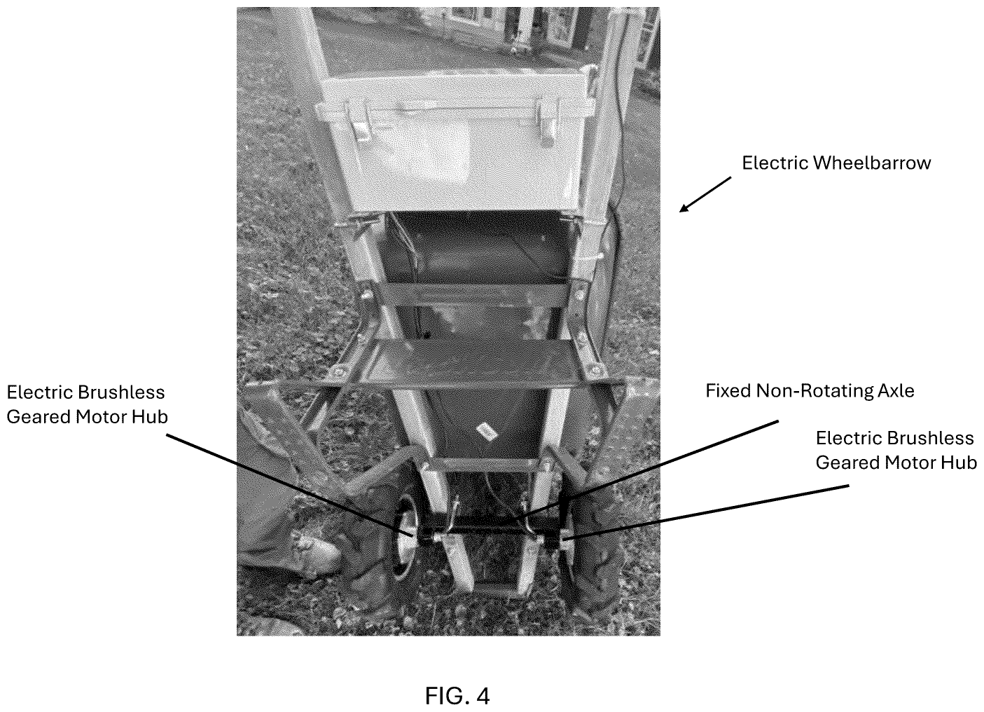

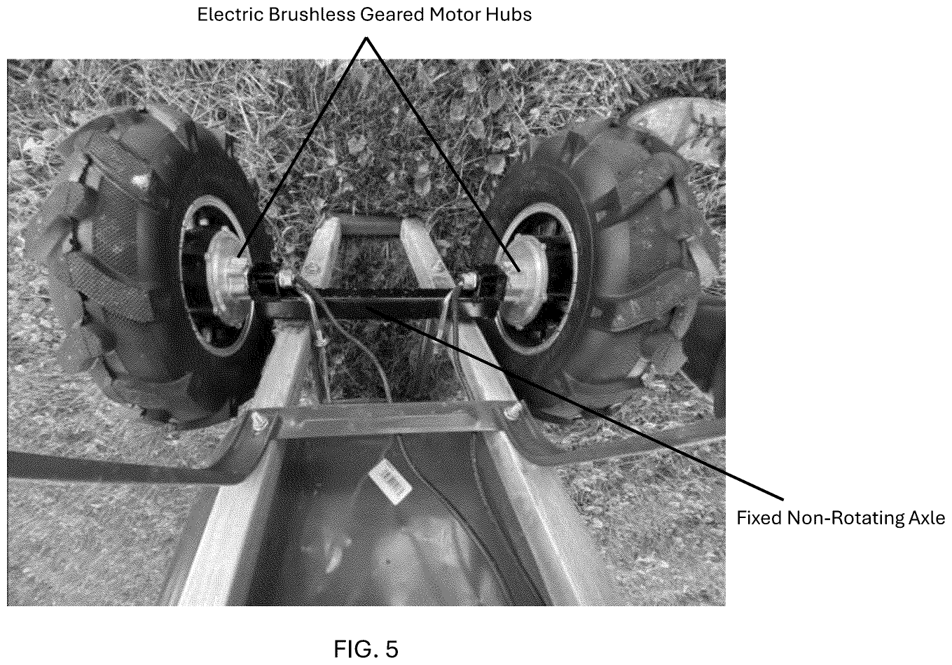

FIGS. 4 and 5 show the electric wheelbarrow's first and second wheels, fixed non-rotating axle including opposite first and second end portions to which the first and second wheels are rotatably coupled, and first and second electric brushless geared hub motors. The first and second electric brushless geared hub motors are configured to be operable for distributing electrical power between the first and second wheels for rotating/driving the first and second wheels, respectively. Advantageously, the use of two electric brushless geared hub motors and the non-rotating fixed axle provides a high level of wheelbarrow stability, e.g., when the electric wheelbarrow is being pushed and/or maneuvered, etc.

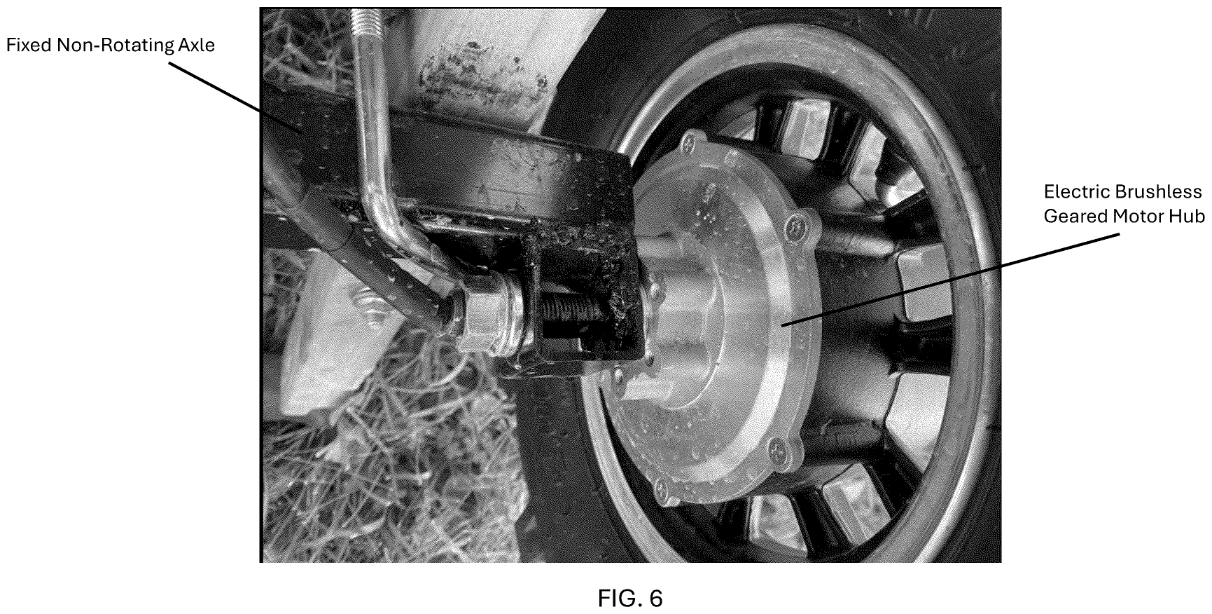

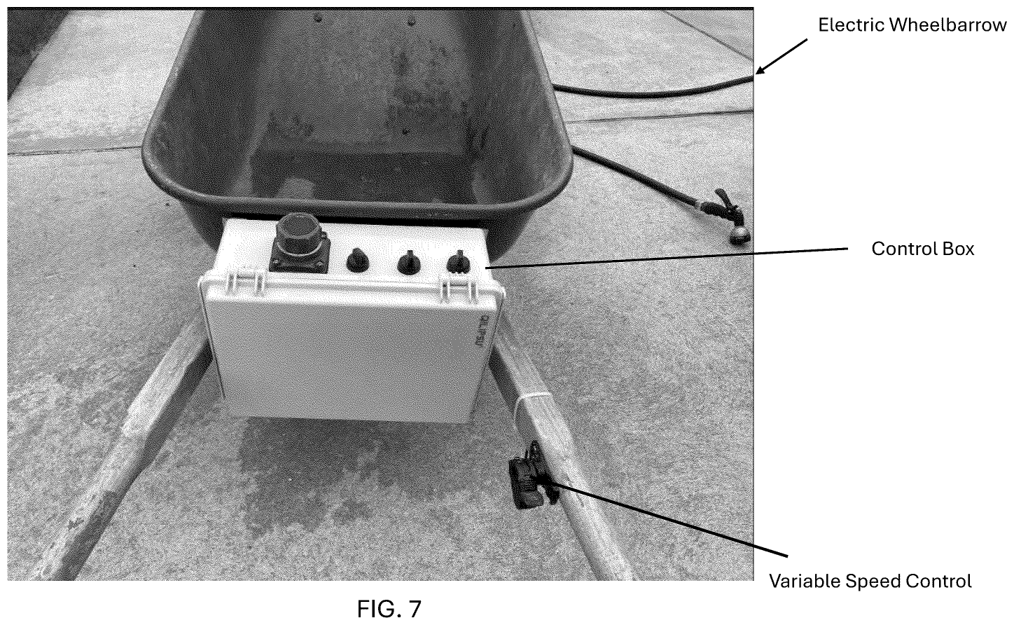

FIG. 6 shows a closeup of one of the wheels and electric brushless geared hub motor. FIG. 7 shows the control box and variable speed control (e.g., thumb-actuated throttle/accelerator lever, etc.) of the electric wheelbarrow.

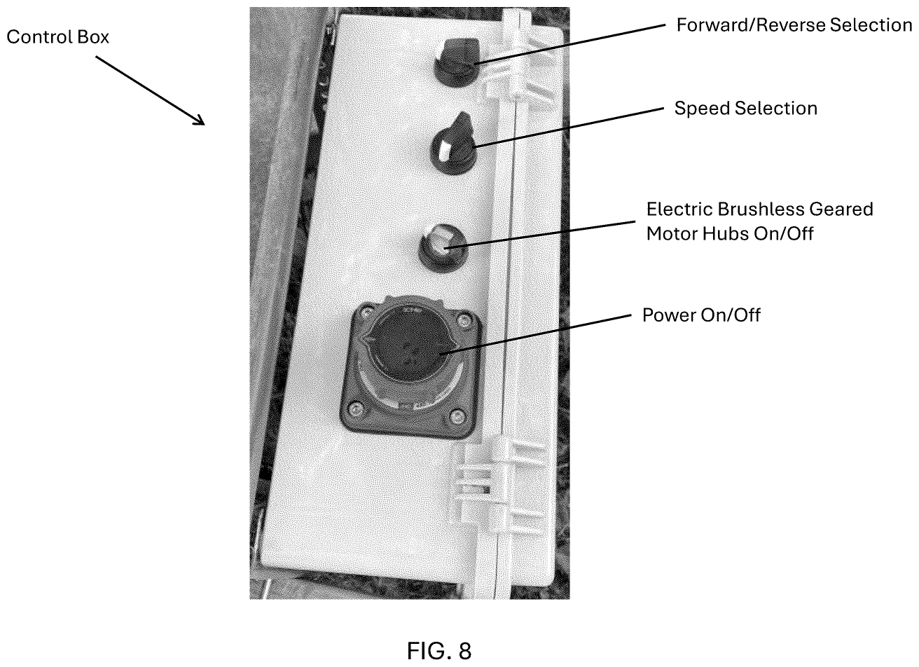

FIG. 8 shows a close up of the controls of the electric wheelbarrow's control box. The controls are accessible to a user (e.g., contractor, gardener, construction worker, other user, etc.) for controlling the electrically-powered operation of the electric wheelbarrow. In the exemplary embodiment shown in FIG. 8, the controls include a power ON/Off rotatable knob including a voltage display, an ON/OFF rotatable switch for the electric brushless geared motor hubs, a rotatable switch for selecting speed (e.g., a 3-speed switch for selecting low speed, medium speed, high speed, etc.), and forward/reverse rotatable switch.

By way of example, the electric wheelbarrow may be configured to have a forward speed of greater than 0 miles per hour up to at least 4.2 miles per hour, a reverse speed of greater than 0 miles per hour up to at least 4.2 miles per hour, and a load capacity of at least 500 pounds at a maximum slope of at least 25 degrees.

In exemplary embodiments, the electric wheelbarrow does not include any braking system such that the electric wheelbarrow when powered off may be used as a conventional non-powered wheelbarrow. But alternative embodiments may be provided with a braking system, e.g., via an electric braking system via a brushless motor hold, etc. and/or with a mechanical disc braking system, etc.

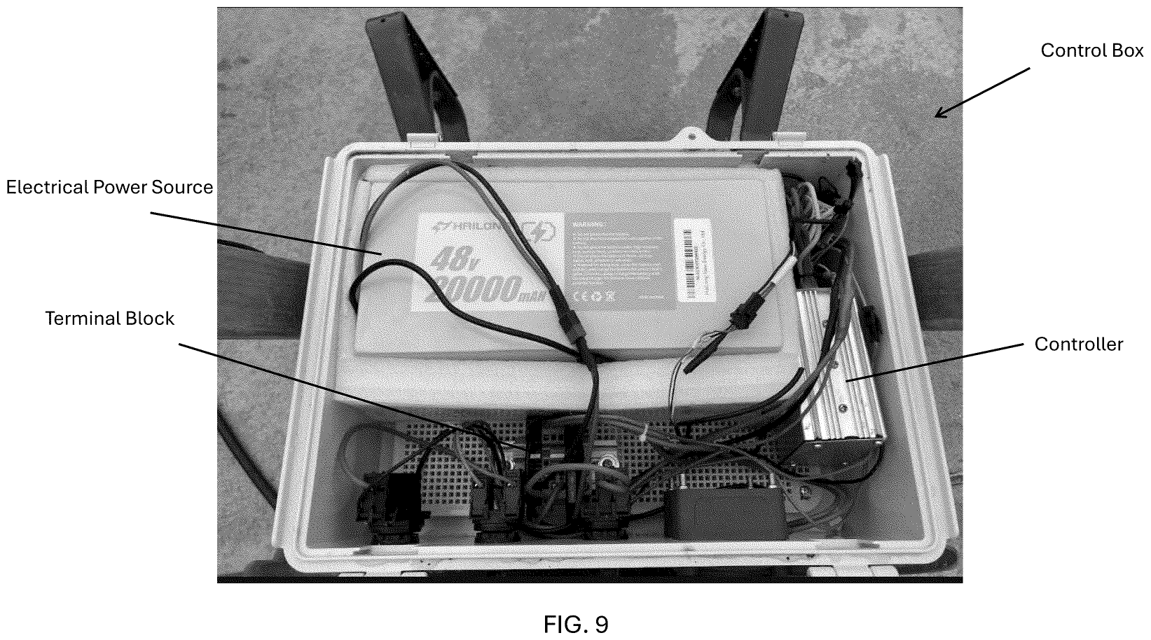

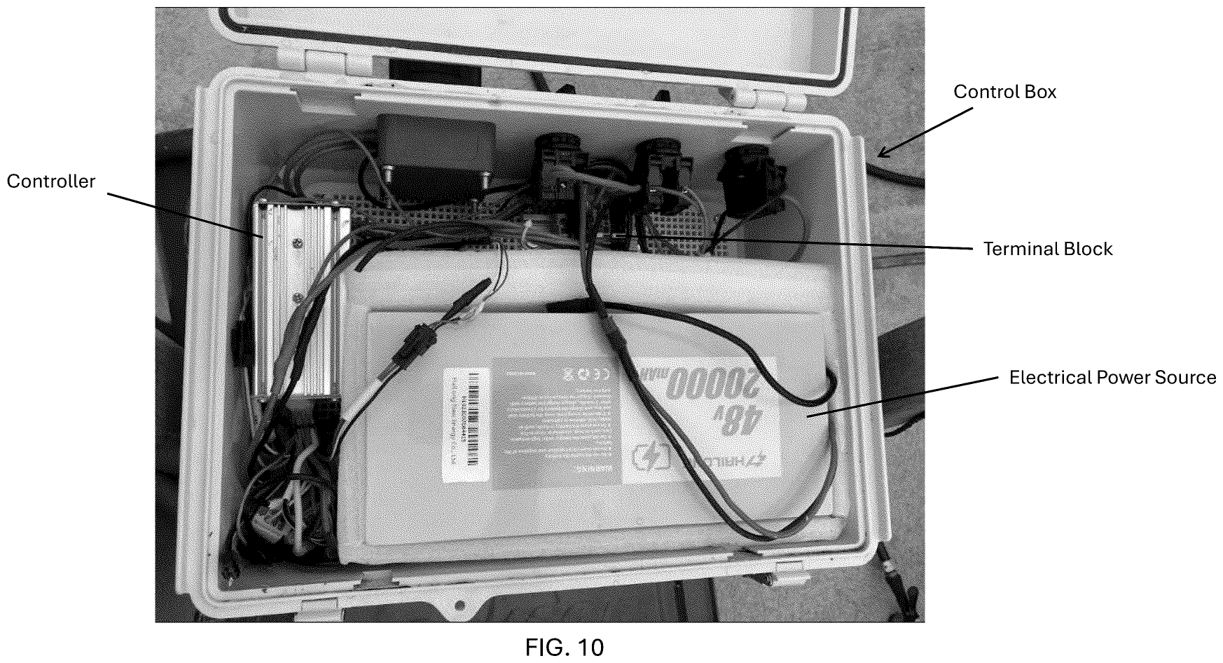

FIGS. 9 and 10 show the interior of the control box including the electrical power source, controller, and terminal block of the electric wheelbarrow. In this exemplary embodiment, the electrical power source comprises a 48 volt (V) 20000 milliamp hours (mAH) battery. Other exemplary embodiments may include a differently configured electrical power source, e.g., a battery with higher or lower voltage and/or with higher or lower milliamp hours, etc. For example, other exemplary embodiments may be configured to accommodate up to 60 volt battery or more, such as a 36 volt battery, 48 volt, 52 volt battery, 60 volt battery, etc. Increasing the voltage may advantageously allow an operator of the electric wheelbarrow to do more work with less manpower.

In this exemplary embodiment, the controller comprises a dual brushless motor controller operable for separately and/or independently controlling/adjusting the electrical power provided to each of the first and second electric brushless geared motor hubs for rotating/driving the respective first and second wheels separately and/or independently from each other. Accordingly, the controller is thus operable such that the same electrical power level or different electrical power levels may be supplied to the first and second electric brushless geared motors for rotating/driving the respective first and second wheels at a same speed or at different speeds.

In this exemplary embodiment, the terminal block includes a 25 amp fuse for safety. Other exemplary embodiments may include differently configured safety features, e.g., a fuse larger or smaller than a 25 amp fuse, etc.

Exemplary embodiments of the electric wheelbarrows disclosed herein may include or provide one or more of (but not necessarily all of) the following features and/or advantages:
significantly more power and torque (e.g., four times more power and torque, etc.) than conventional electric wheelbarrows;
two electric brushless geared motor hubs (one for each wheel) controllable by a dual brushless motor controller and configured to max out at 800 Watts each thereby providing a total of 1600 Watts (e.g., more than 2 horsepower, etc.);
configured to accommodate up to 60-volt power structure (or higher), such as a 48-volt power structure, which helps provide increased power output and twice the electrical power of a conventional 24-volt power structure at the same amount of amps;
ideally suited for the contractor market given the electric wheelbarrow's high power and torque and heavy duty build welded static axle to which are attached the electric brushless geared hub motors;
a 20 amp hour (Ah) battery for a long run time;
enables significantly increased and more efficient workload than conventional wheelbarrows;
increased voltage allows an operator of the electric wheelbarrow to do more work with less energy;
lighter and narrower footprint than conventional mechanized skid steer loaders;
easy to maneuver and push across difficult uneven terrain and push up inclines even when fully loaded;
brushless controller operable with 36V, 48V, 52V, 56V, and 60V, such as an all-electric 48-volt dual brushless motor system with a 48 volt 20 Ah rechargeable deep cycle non-spillable using lithium ion battery technology; and/or
the electric wheelbarrow may be configured to include first and second 16-inch diameter wheels that provide torque within a range from about 90 to about 110 foot pounds and with almost 2 horsepower when a 56V electrical power source is used; or the electric wheelbarrow may be configured to include first and second 16-inch diameter wheels that provide torque within a range from about 85 to about 90 foot pounds when a 48V electrical power source is used; and/or 8 the electric wheelbarrow may be configured to be operable with positraction in which both of the first and second wheels of the electric wheelbarrow are each rotatable separately and/or independently from each other; and/or the shared power and slippage of the electric wheelbarrow may enable the electric wheelbarrow to have considerably higher torque and power than conventional wheelbarrows, which may have ¼ or less of the torque and power as the exemplary electrical wheelbarrows disclosed herein.

Aspects of the present disclosure should not be limited solely to two-wheeled electric wheelbarrows. For example, other exemplary embodiments may include other wheeled electrically powered utility vehicles, such as electric self-propelled utility wagons and utility carts having four wheels, electrically powered utility cart and wheelbarrow combinations, other three or four wheeled electric utility vehicles, etc.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected, or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric wheelbarrow comprising:
a fixed non-rotating axle including opposite first and second end portions;
first and second wheels rotatably coupled to the respective first and second end portions of the fixed non-rotating axle; and
first and second electric brushless geared hub motors respectively coupled to the first and second wheels, the first and second electric brushless geared hub motors are configured to be operable for rotating/driving the respective first and second wheels, respectively, when electrical power is supplied to the first and second electric brushless geared hub motors.

2. The electric wheelbarrow of claim 1, wherein the electric wheelbarrow includes a controller configured to be operable for controlling operation of the first and second electric brushless geared motor hubs for rotating/driving the respective first and second wheels.

3. The electric wheelbarrow of claim 2, wherein the controller is configured to be operable for separately and/or independently controlling/adjusting electrical power provided to each of the first and second electric brushless geared motor hubs for rotating/driving the respective first and second wheels separately and/or independently from each other.

4. The electric wheelbarrow of claim 2, wherein the controller is selectively operable such that:
each of the first and second electric brushless geared motors is provided with about a same electrical power level for rotating/driving the respective first and second wheels at about a same speed; or
each of the first and second electric brushless geared motors is provided with different electrical power levels for respectively rotating/driving the first wheel at a first speed and the second wheel at a second speed different than the first speed.

5. The electric wheelbarrow of claim 2, wherein the controller comprises a dual brushless motor controller.

6. The electric wheelbarrow claim 2, wherein the controller comprises a brushless controller configured to be operable with any one of a 36 volt electrical power source, a 48 volt electrical power source, a 52 volt electrical power source, a 56 volt electrical power source, and a 60 volt electrical power source.

7. The electric wheelbarrow of claim 1, wherein the electric wheelbarrow is configured to accommodate up to at least a 60 volt electrical power source.

8. The electric wheelbarrow of claim 1, wherein the electric wheelbarrow includes a 36 volt electrical power source, a 48 volt electrical power source, a 52 volt electrical power source, a 56 volt electrical power source, or a 60 volt electrical power source.

9. The electric wheelbarrow of claim 1, wherein the electric wheelbarrow includes a 48 volt 20000 milliamp battery for supplying electrical power to the first and second electric brushless geared motors for rotating/driving the respective first and second wheels.

10. The electric wheelbarrow of claim 1, wherein the electric wheelbarrow includes controls accessible to a user for controlling the electrically-powered operation of the electric wheelbarrow, the controls including:
a power ON/OFF rotatable knob including a voltage display;
an ON/OFF rotatable switch for the first and second electric brushless geared motor hubs;
a rotatable switch for selecting forward or reverse; and
a rotatable switch for selecting a speed including one of a slow speed, a medium speed, and a high speed.

11. The electric wheelbarrow of claim 1, wherein the electric wheelbarrow includes a variable speed control for allowing a user to increase or decrease a rotational speed of the first and second wheels by the respective first and second electric brushless geared hub motors.

12. The electric wheelbarrow of claim 11, wherein the variable speed control comprises a thumb-actuated rotatable lever mounted on a handle of the electric wheelbarrow.

13. The electric wheelbarrow of claim 1, wherein the electric wheelbarrow includes a control box located behind a container of the electric wheelbarrow between two handles of the electric wheelbarrow.

14. The electric wheelbarrow of claim 13, wherein the electric wheelbarrow includes:
an electrical power source within an interior of the control box for supplying electrical power to the first and second electric brushless geared motors for rotating/driving the respective first and second wheels; and
a controller within the interior of the control box for controlling how much electrical power is provided to the first and second electric brushless geared motors for rotating/driving the respective first and second wheels.

15. The electric wheelbarrow of claim 14, wherein the controller is configured to be selectively operable such that:
each of the first and second electric brushless geared motors is provided with about a same electrical power level for rotating/driving the respective first and second wheels at about a same speed; or
each of the first and second electric brushless geared motors is provided with different electrical power levels for respectively rotating/driving the first wheel at a first speed and the second wheel at a second speed different than the first speed.

16. The electric wheelbarrow of claim 14, wherein the electrical power source comprises a 48 volt 20000 milliamp battery.

17. The electric wheelbarrow of claim 14, wherein the electrical power source comprises a 36 volt battery, a 48 volt battery, a 52 volt battery, a 56 volt battery, or a 60 volt battery.

18. The electric wheelbarrow of claim 13, wherein the electric wheelbarrow includes controls on top of the control box that are accessible to a user for controlling the electrically-powered operation of the electric wheelbarrow.

19. The electric wheelbarrow of claim 18, wherein the controls include:
a power ON/OFF rotatable knob including a voltage display;
an ON/OFF rotatable switch for the first and second electric brushless geared motor hubs;
a rotatable switch for selecting forward or reverse; and
a rotatable switch for selecting a speed including one of a slow speed, a medium speed, and a high speed.

20. The electric wheelbarrow of claim 1, wherein the first and second electric brushless geared hub motors are each configured to max out at 800 Watts thereby providing a total of 1600 Watts.

21. The electric wheelbarrow of claim 1, wherein the electric wheelbarrow is configured to have a forward speed of greater than 0 miles per hour up to at least 4.2 miles per hour, a reverse speed of greater than 0 miles per hour up to at least 4.2 miles per hour, and a load capacity of at least 500 pounds at a maximum slope of at least 25 degrees.
